(19) United States
(12) Patent Application Publication
(10) Pub. No.: US 2009/0174525 A1
(43) Pub. Date: Jul. 9, 2009

(54) Communication system and communication method

(76) Inventor: Shinnichiro Yamauchi, Osaka (JP)

Correspondence Address: MCDERMOTT WILL & EMERY LLP, 600 13TH STREET, NW, WASHINGTON, DC, 20005-3096, US

(21) Appl. No.: 10/585,075

(22) PCT Filed: Feb. 21, 2005
(86) PCT No.: PCT/JP05/02723

§ 371 Date: Jun. 29, 2006

(30) Foreign Application Priority Data
Mar. 2, 2004 (JP) 2004-057393

(51) Int. Cl. G05B 19/00

(52) U.S. Cl. 340/5.8

(57) ABSTRACT

An object of the invention is to provide a communication system for inputting authentication information to a communication machine without providing an external machine access interface for inputting authentication information.

The communication system of the invention is a communication system having an authentication function using authentication information and enabling communications to be conducted at least between two Bluetooth machines 1 (704) and 2 (705), and includes a Bluetooth security server 703 for wirelessly supplying authentication information 702a, 702b to the Bluetooth machine 1 (704), 2 (705).

### TECHNICAL FIELD

This invention relates to a communication system and a communication method having an authentication function using authentication information and enabling communications to be conducted at least between two communication machines.

### BACKGROUND ART

Hitherto, for information machines to communicate with each other, connection and communications have been permitted even if the communication parties are any machines in the simplest case. To conduct communications with a plurality of machines, a method of using user IDs and passwords for management and operation has also been widely used to identify each connection machine, manage the access right, and provide security.

Particularly, in the Internet coming into remarkable widespread use in recent years, access management based on user IDs and passwords is widely generally conducted. The user transmits user ID and password information at the network connection time and can start communications if the user is authenticated. In a server-client model network, the user IDs and the passwords are recorded and managed in the server and when a connection request comes from a client, the sent user ID and password information is checked and if the user ID and password information matches that recorded in the server, the access right is granted and communications are started. When the user first conducts communications, the user information is previously set in the server or the user connects to the server as guest account and then transmits the user ID and the password from the client terminal and the user ID and the password are set in the server. In recent years, a wireless network using radio waves as physical media of a network has come into widespread use. Also in the wireless network, access right management similar to that mentioned above is conducted in a server-client model network.

If such an access right management function is installed in a short-range wireless network machine as represented by Bluetooth, particularly a portable machine, the machine may be used anywhere and thus it is predicted that the occasion when machines not connected so far at all to each other communicate with each other will be increased. Because of wireless communications, the user is hard to know when and which machines are connected to each other, and it becomes important to realize firm security to prevent harm such as theft of user information while the user is unaware of communications. In the Bluetooth standard, to cope with the security problem, a method of performing authentication before machine-to-machine connection communications is considered. The operation of machine authentication of a link layer in the Bluetooth standard is as follows:

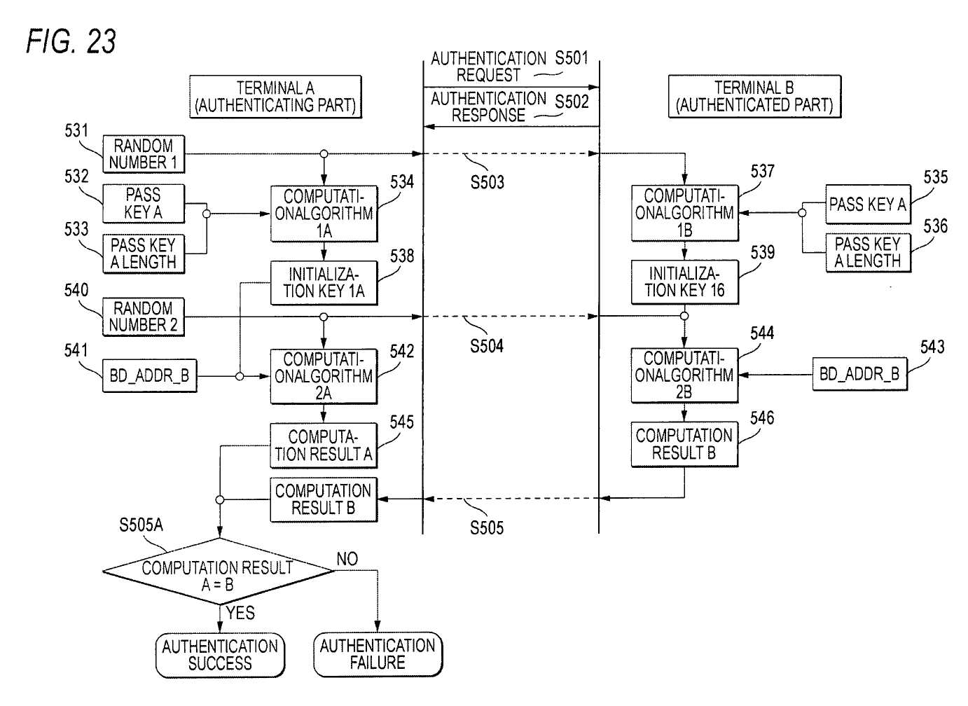

FIG. 23 is a drawing to describe the operation of machine authentication in the Bluetooth standard. The machine authentication is performed between one machine and one machine. FIG. 23 represents transfer at the authentication processing time between two terminals A and B each installing a wireless communication function based on the Bluetooth standard and processing executed in each terminal in time sequence. It is assumed that the time elapses from the top to the bottom of the FIG. 23. The left to the left solid line of FIG. 23 represents the inside of the terminal A and the right to the right solid line represents the inside of the terminal B. Each dashed line arrow between the two solid lines at the center of FIG. 23 indicates radio wave information communications between the terminals A and B. At the communication connection time, either of the terminals A and B starts an authentication process as the authenticating part for authenticating the communication party or the authenticated part and makes a request for starting an authentication procedure. Here, it is assumed that user A operates the terminal A and user B operates the terminal B.

FIG. 23 shows the case where the terminal A is the authenticating part for authenticating the communication party and the terminal B is the authenticated part authenticated as the communication party. First, the terminal A sends an authentication request to the terminal B at step S501 and starts an authentication process. The terminal B returns an authentication acceptance response at step S502 and starts the authentication procedure. At step S503, random number 1 (531) generated in the terminal A is transmitted to the terminal B and on the other hand, the user A of the terminal A is requested to enter a character string or a digit string called Bluetooth pass key (hereinafter, pass key) owned by the terminal A. The pass key is machine-unique password information that each Bluetooth compatible terminal has, and is information used for conducting the authentication procedure with a terminal not connected so far, in other words, a first connected terminal. Entered pass key A (532) and pass key A length 533 of the length of the pass key A are used as input to a computation algorithm 1A 534. The computation algorithm 1A 534, which is an initialization key generation algorithm, is executed in the terminal A for generating an initialization key 1A 538 of key information. In the terminal B receiving the random number 1 (531), like the terminal A, the user B is requested to enter pass key A 535 and the entered pass key A 535 and pass key A length 536 of the length of the pass key A are used as input to a computation algorithm 1B 537. The pass key A 532 entered by the user A into the terminal A and the pass key A 535 entered by the user B into the terminal B should be the same. In other words, the authenticating part authenticates the authenticated part as the communicating party with the authenticating part provided that the authenticated part enters the pass key of the authenticating part correctly. Therefore, the pass key A length 533 and the pass key A length 536 should also be the same. The computation algorithm 1B 537 executed in the terminal B and the computation algorithm 1A 534 executed in the terminal A are also the same algorithms. An initialization key 1B 539 is also generated in the terminal B like the terminal A and should be the same as the initialization key 1A 538 generated in the terminal A.

Next, the terminal A generates random number 2 (540) different from the random number 1 (531) and transmits the random number 2 to the terminal B at step S504. The random number 2 (540), the initialization key 1A 538, and Bluetooth Device Address (BD_ADDR_B) 541 of the terminal B of the authenticated part are used as input to a computation algorithm 2A 542, and computation result A 545 is obtained. The computation algorithm 2A 542 is a connection authentication algorithm and is executed in the terminal A. BD_ADDR_B is the address number unique to each Bluetooth machine and is contained in information exchanged when machines establish connection at the preceding stage of starting the authentication procedure processing, namely, before step S501 is executed and therefore is already known information at the point in time.

In the terminal B receiving the random number 2 (540) like the terminal A, the random number 2 (540), the initialization key 1B 539, and BD_ADDR_B 543 of the terminal B are used as input to a computation algorithm 2B 544, and computation result B 546 is obtained. The computation algorithm 2B 544 executed in the terminal B and the computation algorithm 2A 542 executed in the terminal A are the same algorithms. BD_ADDR_B 541 used in the terminal A and BD_ADDR_B 543 used in the terminal B are the same information.

Next, the terminal B transmits the computation result B 546 to the terminal A at step S505. In the terminal A, a comparison is made between the computation result A 545 produced by computation in the terminal A and the computation result B 546 produced by computation in the terminal B and transmitted from the terminal B at step S505A. If the values of the computation result A and the computation result B equal, the authentication results in success; if the values differ, the authentication results in failure. If the authentication results in success, the terminal B is authenticated as the valid communicating party and the process proceeds to communication processing that follows. If the authentication results in failure, the connection is disconnected and the process is terminated.

To more enhance the security level, after the authentication results in success, the authentication roles of the terminals A and B are exchanged, namely, this time the terminal A becomes the authenticated part and the terminal B becomes the authenticating part and using the random number generated in the terminal B, the pass key B owned by the terminal B, and BD_ADDR_A of the terminal A as parameters, authentication can also be performed according to a similar procedure to that in FIG. 23 for performing authentication processing between the terminals. However, the recognition processing with the roles exchanged can be skipped.

The authentication operation described above is applied to the case where the users of both the terminals for conducting communications with each other can enter pass keys. However, some Bluetooth machines are hard for the user to directly enter a pass key or do not enable the user to directly enter a pass key. In such a machine, a method is proposed wherein a pass key is previously set in nonvolatile memory contained in the machine through an external machine access interface from an external machine (such as a memory card or a cable) and at the authentication time, the pass key is read from the internal nonvolatile memory, etc., and is used for authentication processing, whereby the need for the user of the machine not enabling the user to directly enter the pass key to enter the pass key is eliminated (for example, refer to patent document 1).

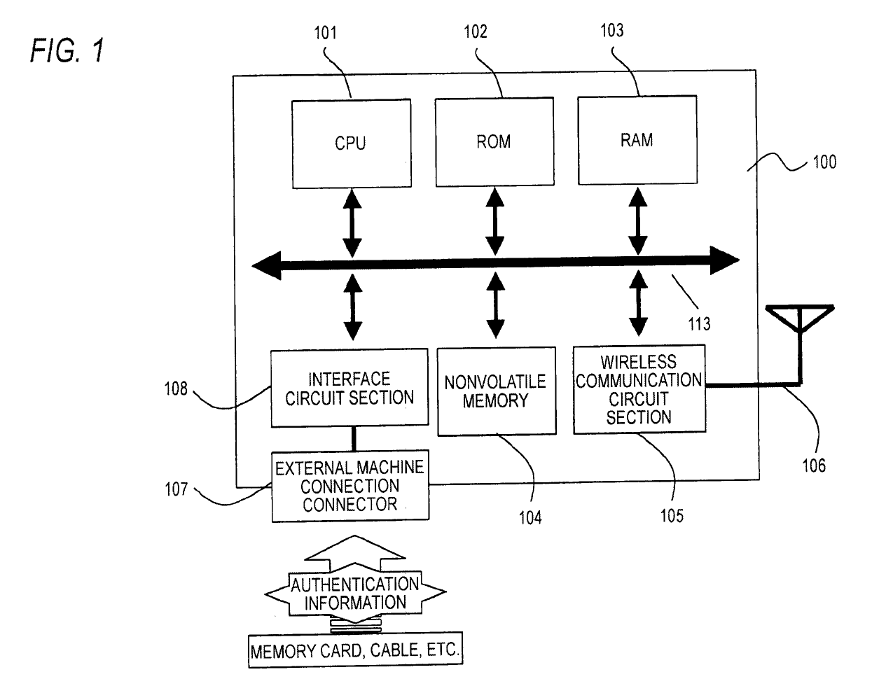

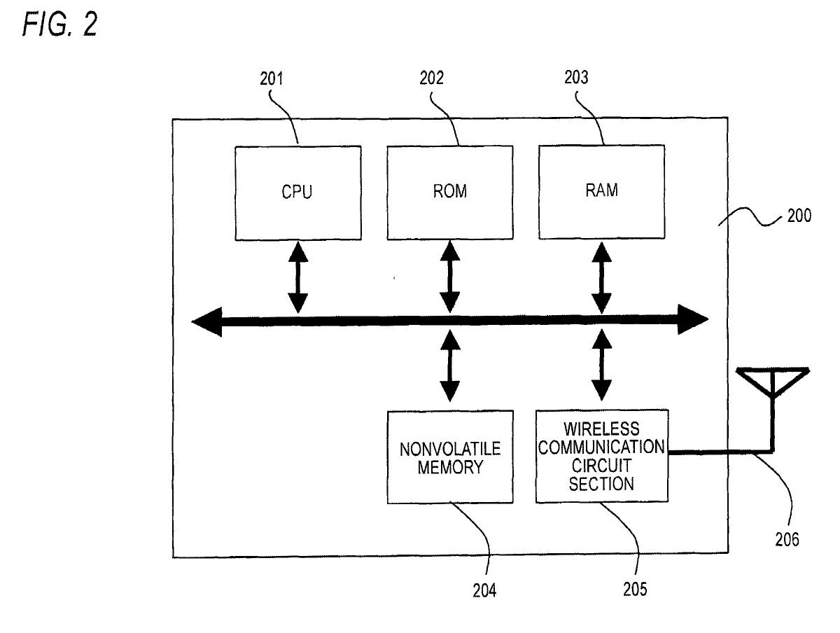

FIG. 1 is a block diagram to show the internal configuration of a Bluetooth machine having input means in a related art, and FIG. 2 is a block diagram to show the internal configuration of a Bluetooth machine having no input means in a related art. A Bluetooth machine 100 shown in FIG. 1 is configured as follows: BD_ADDR and the pass key of a connection communicating party (Bluetooth machine 2) are previously written into memory of the Bluetooth machine 100 through an external machine and at the authentication processing time, the BD_ADDR and the pass key are read for use. A Bluetooth machine 200 shown in FIG. 2 is a machine having no input means of a pass key and stores the fixed pass key in the main unit.

The Bluetooth machine 100 shown in FIG. 1 has a CPU 101, ROM 102, RAM 103, nonvolatile memory 104, a wireless communication circuit section 105, an antenna 106, an external machine connection connector 107, and an interface circuit section 108, and the components except the antenna 106 or the external machine connection connector 107 are connected by an internal bus 113 as shown in the figure.

The CPU 101 operates in accordance with a program stored in the ROM 102 and controls various types of operation of the Bluetooth machine 100. The ROM 102 is nonvolatile memory previously storing a control procedure, data, etc., of the Bluetooth machine 100. The RAM 103 is used as a work area for conversion work to data transmitted from an external machine, a work area used for computation of the CPU 101, etc., or an area for temporarily storing communication data transmitted and received through the wireless communication circuit section, various settings, etc. The nonvolatile memory 104 is rewritable and stores and retains various settings of the machine, BD_ADDR of the communicating party used for Bluetooth communications, link key information used for communications with the previously connected Bluetooth machine, and the like. The wireless communication circuit section 105 is made up of a high frequency circuit section required for wireless communications, an encoding-decoding circuit section, FIFO memory used at the wireless communication time, nonvolatile memory storing BD_ADDR_D of the machine, pass key D of the machine, and the like, and the antenna 106 is connected to the wireless communication circuit section.

The external machine connection connector 107 is an interface for connecting an external machine and the Bluetooth machine 100; for example, it is assumed to be a memory card, a connector, etc. The interface circuit section 108 for external machine connection includes a function of conducting data communications with an external machine. It transmits data to the external machine and receives data from the external machine under the control of the CPU 101.

The Bluetooth machine 200 shown in FIG. 2 has a CPU 201, ROM 202, RAM 203, nonvolatile memory 204, a wireless communication circuit section 205, and an antenna 206, which are connected by an internal bus 212 as shown in the figure.

The CPU 201 operates in accordance with a program stored in the ROM 202 and controls various types of operation of the Bluetooth machine 200. The ROM 202 is nonvolatile memory previously storing a control procedure, data, etc., of the Bluetooth machine 200. The RAM 203 is used as a work area for conversion work to data transmitted from an external machine, a work area used for computation of the CPU 101, etc., or an area for temporarily storing communication data transmitted and received through the wireless communication circuit section, various settings, etc.

The nonvolatile memory 204 is rewritable and stores and retains various settings of the machine, BD_ADDR of the communicating party used for Bluetooth communications, link key information used for communications with another Bluetooth machine previously connected, and the like.

The wireless communication circuit section 205 is made up of a high frequency circuit section required for wireless communications, an encoding-decoding circuit section, FIFO memory used at the wireless communication time, nonvolatile memory storing BD_ADDR_P of the machine, pass key P of the machine, and the like, and the antenna 206 is connected to the wireless communication circuit section.

Hitherto, the following settings have been made in the Bluetooth machine 100 to perform authentication processing with the Bluetooth machine 200 having no pass key input function: A memory card or a cable is connected to the external machine connection interface of the Bluetooth machine 100 shown in FIG. 1 and the Bluetooth address of the Bluetooth machine 200 (BD_ADDR_P) and the pass key information of the Bluetooth machine 200 (pass key P) previously examined are written into a predetermined area of the nonvolatile memory 204 in the Bluetooth machine 100 as list information.

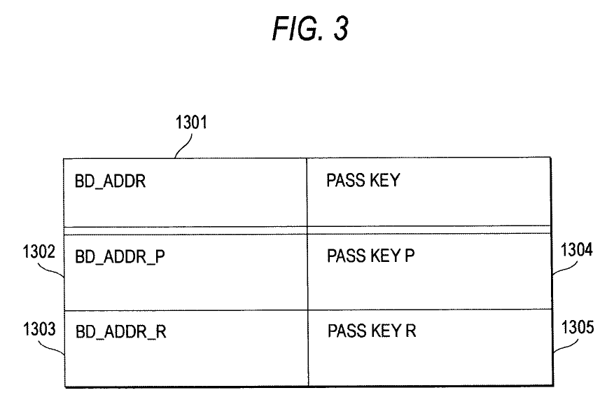

FIG. 3 is a drawing to show a list of Bluetooth addresses and pass keys in the related art and shows an example of a pass key list 1301 stored in the nonvolatile memory 204. As shown in the figure, BD_ADDR and pass key are stored in a pair. In FIG. 3, the list has two pairs of (BD_ADDR_P 1202 and pass key P 1203) and (BD_ADDR_R 1204 and pass key P 1205). Here, the pass key list of two pairs is illustrated, but the number of pairs is not limited.

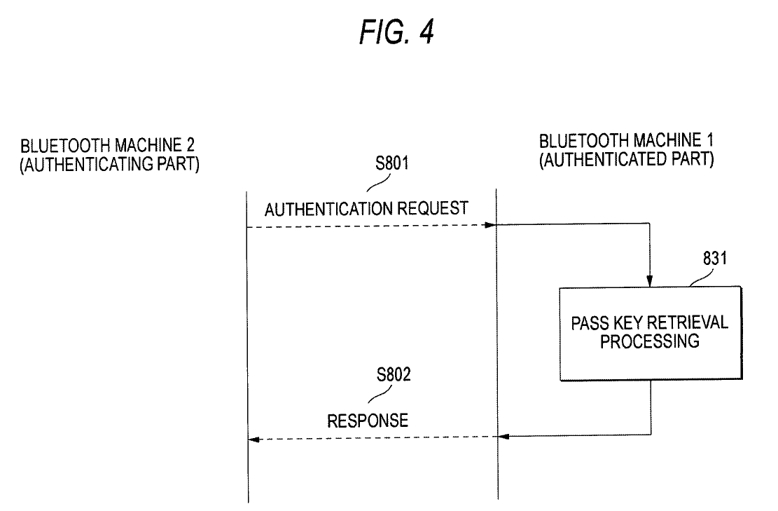

FIG. 4 is a drawing to show a Bluetooth connection authentication sequence in the related art and shows authentication processing for executing an authentication procedure with the Bluetooth machine 200 as the authenticating part and the Bluetooth machine 100 as the authenticated part. First, the Bluetooth machine 200 sends an authentication procedure request to the Bluetooth machine 100 (step S801). Upon reception of the authentication request from the Bluetooth machine 200, the Bluetooth machine 100 executes pass key search processing 831. If BD_ADDR_P and pass key P of the Bluetooth machine 200 exist as a result of the pass key search processing 831, the Bluetooth machine 100 transmits an authentication request acceptance response to the Bluetooth machine 200; if they do not exist, the Bluetooth machine 100 does not accept the authentication request as the authenticated part and transmits an authentication role exchange request for making a request for exchanging the roles of the authenticating part and the authenticated part so as for the Bluetooth machine 100 to become the authenticating part to the Bluetooth machine 200 as a response (step S802).

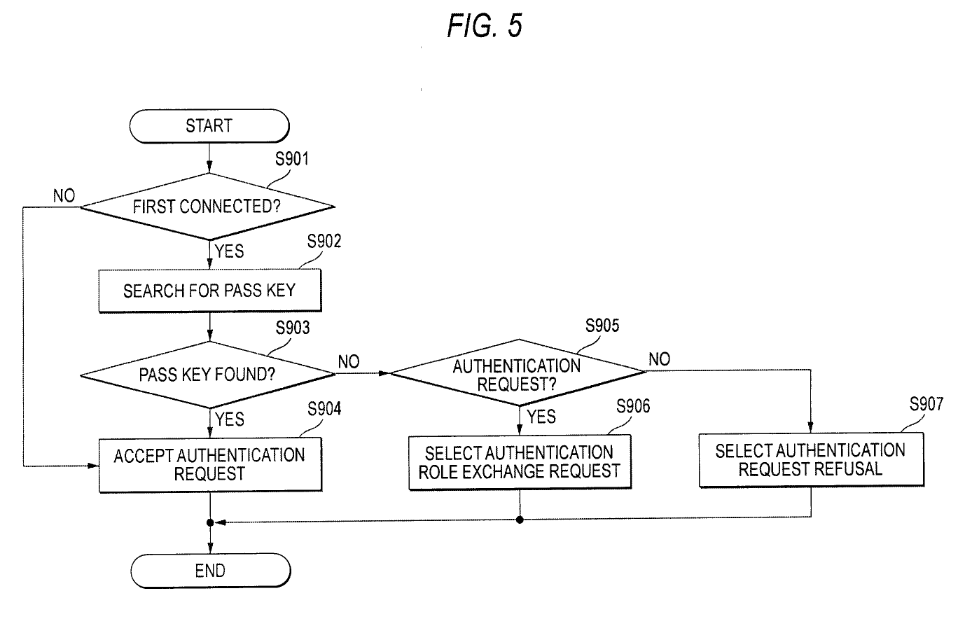

FIG. 5 is a flowchart to show a Bluetooth connection authentication flow in the related art and shows the details of the pass key search processing 831 shown in FIG. 4. In FIG. 5, the processing description is generalized. Here, the processing will be discussed along the example used in the description made so far. First, whether or not the Bluetooth machine 200 transmitting the authentication request is a first connected party this time is determined (step S901). Specifically, a machine connection list stored in the nonvolatile memory 104 of the Bluetooth machine 100 is searched for BD_ADDR matching BD_ADDR_P of the Bluetooth machine 200 and the link key P required for connection. If they are not found, the Bluetooth machine 200 is a first connected machine and thus the process goes to step S902; if they are found, the process goes to step S904.

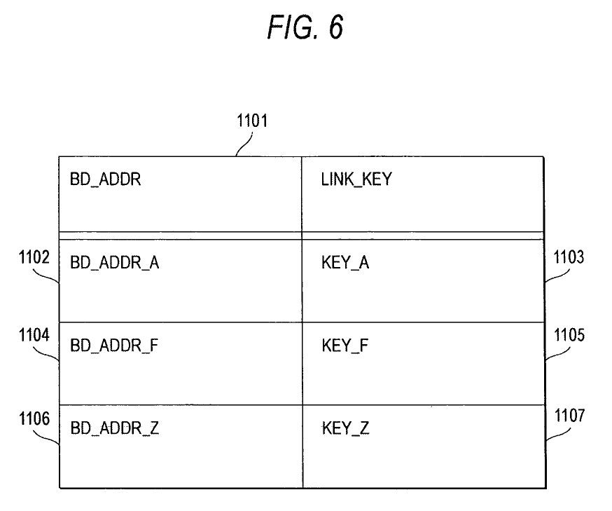

FIG. 6 is a drawing to show a list of Bluetooth addresses and link keys in the Bluetooth machine in the related art and shows an example of the machine connection list. A pair of BD_ADDR and LINK KEY generated at the preceding authentication connection time is stored in a list 1101. In FIG. 6, three pairs of (BD_ADDR_A 1102, KEY_A 1103), (BD_ADDR_F 1104, KEY_F 1105), and (BD_ADDR_Z 1106, KEY_Z 1107) are stored and at step S901, the machine connection list 1101 is searched for BD_ADDR_P of BD_ADDR of the Bluetooth machine 200 and whether or not it exists is determined. Since BD_ADDR_P is not registered in the machine connection list 1101 in FIG. 6, it is determined that the Bluetooth machine 200 is a first connected machine, and the process goes to step S902.

Next, the pass key list 1301 stored in the Bluetooth machine 100 is searched for BD_ADDR_P and pass key P of the Bluetooth machine 200 (step S902). Whether or not pass key P 1304 corresponding to BD_ADDR_P 1302 of the Bluetooth machine 200 is found is determined (step S903). If the pass key P 1304 exists, the process goes to step S904; if the pass key P 1304 does not exist, the process goes to step S905.

At step S904, authentication request acceptance is selected as a response returned to the Bluetooth machine 200. At step S905, whether or not the trigger starting the pass key search processing 831 is an authentication request is determined. If the trigger is an authentication request, the process goes to step S906; if the trigger is an authentication role exchange request, the process goes to step S907.

At step S906, an authentication role exchange request is selected as a response returned to the Bluetooth machine 200. At step S907, an authentication request refusal is selected as a response returned to the Bluetooth machine 200. After any of step S904, 906, or 907 is executed, the pass key search processing 831 is terminated.

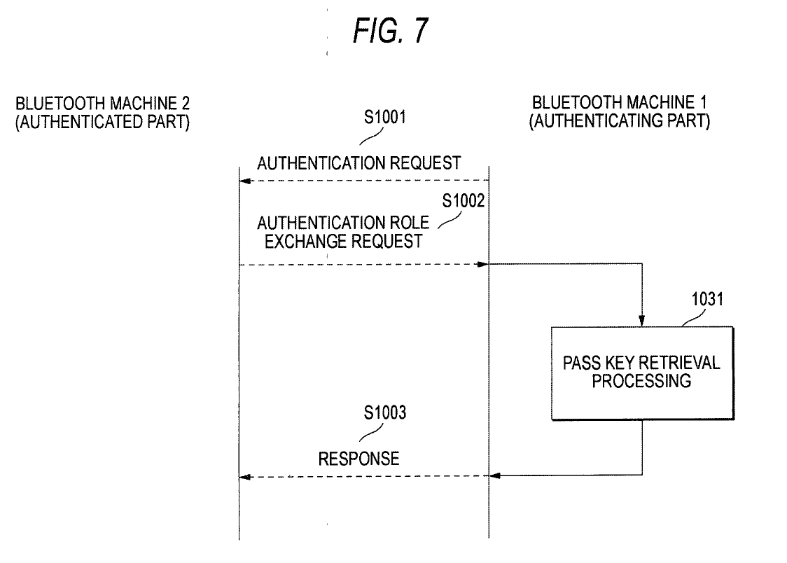

FIG. 7 is a drawing to show a Bluetooth connection authentication sequence in the related art and shows authentication processing for executing an authentication procedure with the Bluetooth machine 200 as the authenticated part and the Bluetooth machine 100 as the authenticating part in an opposite manner to that in FIG. 4. Here, the Bluetooth machine 100 as the authenticating part sends an authentication procedure request to the Bluetooth machine 200 (step S1001) rather than the Bluetooth machine 200 sending an authentication procedure request to the Bluetooth machine 100 as in FIG. 4. Upon reception of the authentication request from the Bluetooth machine 100, the Bluetooth machine 200 does not have pass key input means and thus refuses the authentication request and transmits an authentication role exchange request to the Bluetooth machine 100 (step S1002). Upon reception of the authentication role exchange request from the Bluetooth machine 200, the Bluetooth machine 100 executes pass key search processing 1031. The pass key search processing 1031 mentioned here is the same as pass key search processing 831 shown in FIGS. 4 and 5. If BD_ADDR_P and pass key P of the Bluetooth machine 200 exist as a result of the pass key search processing 1031, the Bluetooth machine 100 transmits an authentication request acceptance response to the Bluetooth machine 200; if they do not exist, the Bluetooth machine 100 does not accept the authentication request as the authenticated part and transmits an authentication request refusal response to the Bluetooth machine 200 (step S1003).

As described above, according to the related art, when terminals not enabling the user to enter the pass key or hard for the user to enter the pass key perform authentication processing at the communication start time, either terminal reads and uses BD_ADDR_P and pass key P of BD_ADDR and pass key of the communicating party terminal preset in memory in the main unit through an external machine, whereby authentication processing can be performed.

However, in the Bluetooth authentication method and communication system in the related art, the external machine connection connector 107 and the interface circuit section 108 for external machine access need to be installed to previously acquire authentication information BD_ADDR and pass key of the communicating party terminal through an external machine and set the authentication information in the memory in the main unit. That is, in the related art, the interface circuit section for external machine access not necessarily required for some products need to be provided, resulting in a factor of hard-to-use terminal or system for the user and a factor of increasing the product cost for the manufacturer.

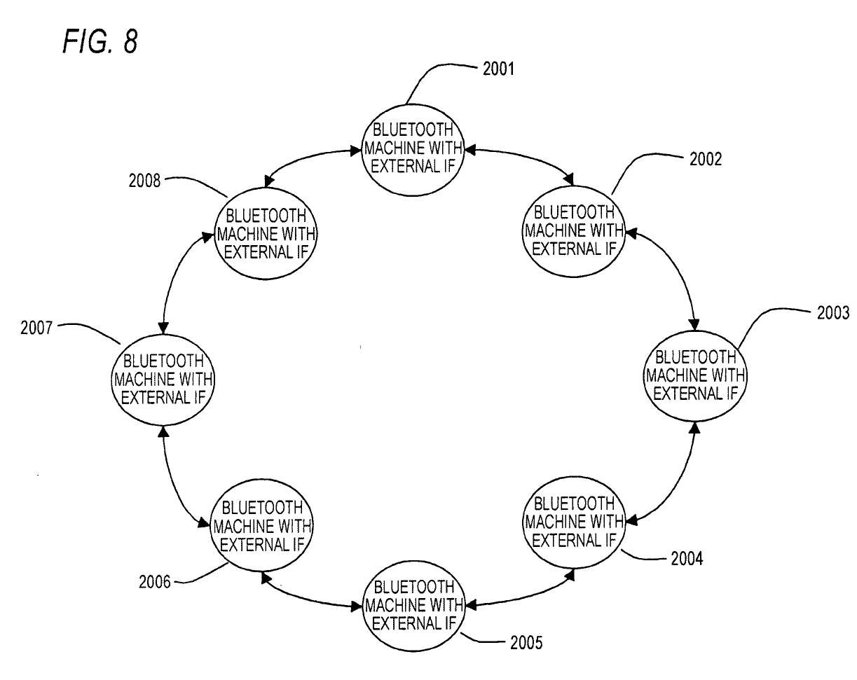

FIG. 8 is a drawing to show an example of a network mode of Bluetooth machines in the related art. In the figure, it is assumed that the Bluetooth machines are Bluetooth-connected to each other. For example, a Bluetooth machine 2001 is Bluetooth-connected to adjacent Bluetooth machines 2002 and 2008. For the Bluetooth connection, pass key information owned by the Bluetooth machine to be connected to is required as described above. Therefore, in FIG. 8, the Bluetooth machine 2001 needs to acquire the pass key information of the adjacent Bluetooth machines 2001 and 2008 through an external machine. Similar comments apply to other Bluetooth machines 2002 to 2008.

Therefore, in the related art, in the Bluetooth network mode as in FIG. 8, each Bluetooth machine requires the external machine connection connector and the interface circuit described above, causing an increase in the cost of the product installing Bluetooth.

A method of previously storing authentication information of each connected Bluetooth machine in internal nonvolatile memory of a Bluetooth machine at factory shipment is also available. In this method, however, the Bluetooth machine can be connected only to the specific Bluetooth machines stored at factory shipment. To connect the Bluetooth machine to other Bluetooth machine products, there is no other way but to change the authentication information in the internal nonvolatile memory of the Bluetooth machine. The Bluetooth machine having no external interface cannot be Bluetooth-connected to any other desired Bluetooth machine. Thus, the interconnectivity of Bluetooth is also lowered and Bluetooth connection is hard to handle for the user in some cases.

Patent document 1: JP-A-2003-152713

### DISCLOSURE OF THE INVENTION

### Problems that the Invention is to Solve

As described above, in the communication system and the communication method in the related art, to enter authentication information, each communication machine needs to be provided with a new external machine access interface and the cost as the communication system is increased.

It is therefore an object of the invention to provide a communication system and a communication method capable of inputting authentication information to a communication machine without providing a new external machine access interface for inputting authentication information.

### Means for Solving the Problems

The communication system of the invention is a communication system having an authentication function using authentication information and enabling communications to be conducted at least between two communication machines, the communication system including a communication section for wirelessly supplying the authentication information to at least one of the at least two communication machines.

According to the configuration, the authentication information is wirelessly supplied to the communication machine, whereby the communication machine can acquire the authentication information using the wireless communication function in the related art and need not be provided with new authentication information input means, so that the communication system cost can be reduced.

According to the communication system of the invention, the communication section is installed in the specific communication machine of the at least two communication machines. Further, according to the communication system of the invention, the communication section installed in the specific communication machine supplies the authentication information to the communication machine other than the specific communication machine, of the at least two communication machines. Still further, according to the communication system of the invention, the communication section is installed separately from the at least two communication machines.

According to the communication system of the invention, the communication section includes an external interface and receives the authentication information via the external interface.

According to the communication system of the invention, the communication section receives the authentication information retained on a memory card connected to the external interface via the external interface. According to the configuration, it is made possible to use information encrypted on a memory card as authentication information, and the security of the communication system can be enhanced.

According to the communication system of the invention, the at least one communication machine includes a function of performing authentication with the communication section using first authentication information uniquely predetermined for each communication machine and a function of performing authentication between the at least two communication machines using second authentication information different from the first authentication information. According to the configuration, the communication machine and the communication section perform authentication using the first authentication information and then the communication section sends the second authentication information to the communication machine, whereby the security of the communication system can be enhanced.

According to the communication system of the invention, the authentication information contains fixed authentication information predetermined for each communication machine and used between the communication section and the at least one communication machine and variable authentication information generated arbitrarily and used for communications between the at least two communication machines. Further, according to the communication system of the invention, the authentication information is address information or password information of the communicating party.

According to the configuration, the authentication information used between the communication machines and the authentication information used between the communication section and the communication machine differ, so that the security of the communication system can be enhanced.

According to the communication system of the invention, the communications between the at least two communication machines or communications between the at least one communication machine and the communication section are wireless communications conforming to Bluetooth standard.

The communication method of the invention is a communication method having an authentication function using authentication information and enabling communications to be conducted at least between two communication machines, the communication method including a supplying step of wirelessly supplying the authentication information to at least one of the at least two communication machines.

According to the communication method of the invention, the supplying step is executed between the specific communication machine of the at least two communication machines and the communication machine other than the specific communication machine, of the at least two communication machines. Further, according to the communication method of the invention, the method further includes a first authentication step of authenticating the at least one communication machine using first authentication information uniquely predetermined for the at least one communication machine, and that if the at least one communication machine is authenticated in the first authentication step, the authentication information is supplied to the at least one communication machine. Still further, according to the communication method of the invention, the method further includes a second authentication step of authenticating the at least two communication machines using second authentication information different from the first authentication information received by the at least one communication machine. Still further, according to the communication method of the invention, the communications between the at least two communication machines or communications with the at least one communication machine are wireless communications conforming to Bluetooth standard.

The communication machine of the invention is a communication machine having a function of performing authentication as to whether or not mutual communications can be conducted using authentication information and starting communications after authentication, the communication machine including means for wirelessly acquiring the authentication information. According to the configuration, the communication machine can acquire the authentication information using the wireless communication function in the related art and need not be provided with new authentication information input means, so that the communication machine cost can be reduced.

### ADVANTAGES OF THE INVENTION

According to the communication system and the communication method of the invention, the authentication information is wirelessly supplied to the communication machine, whereby the communication machine can acquire the authentication information using the wireless communication function in the related art and need not be provided with new authentication information input means, so that the communication system cost can be reduced.

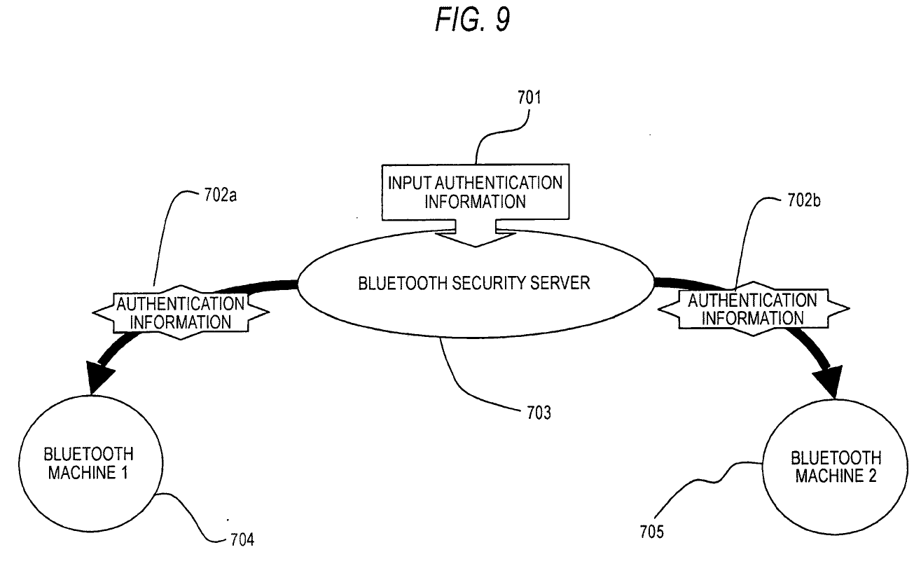

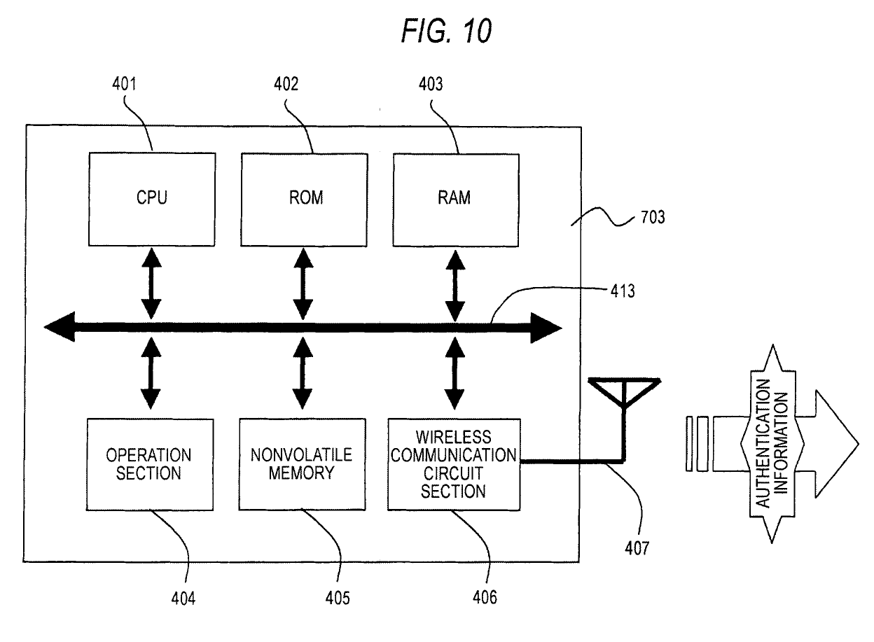

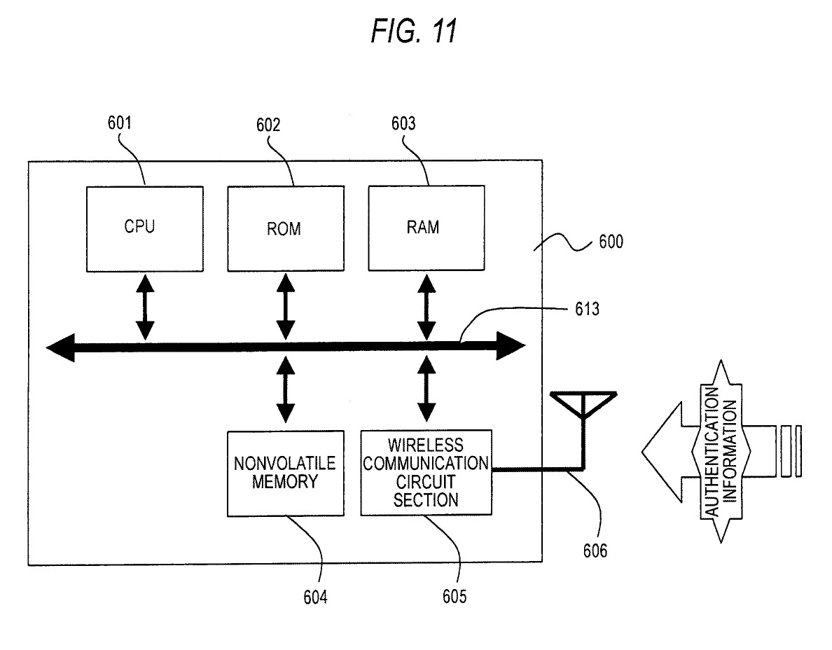

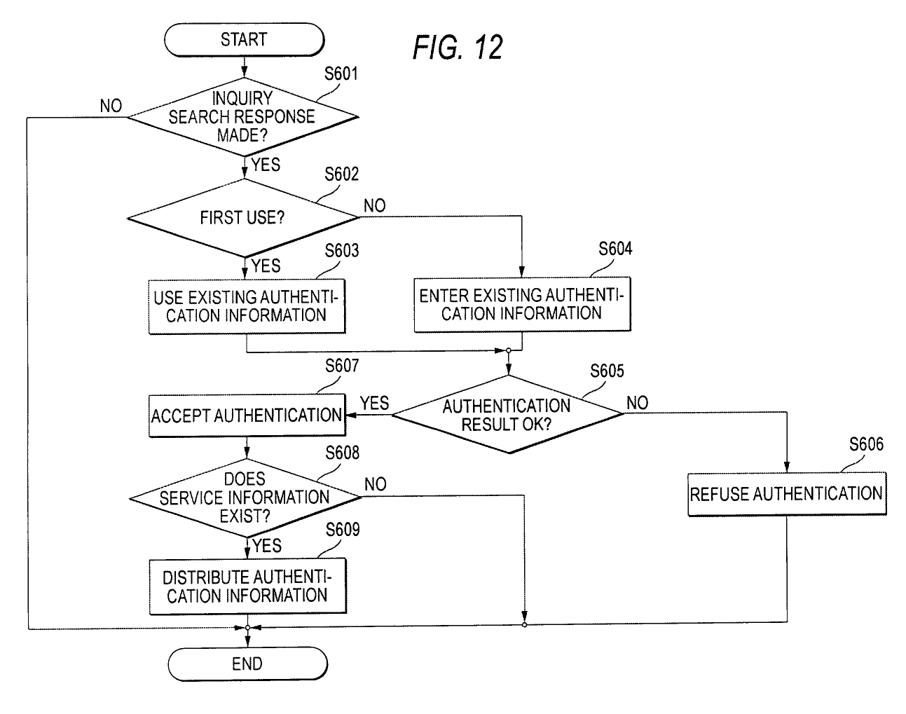

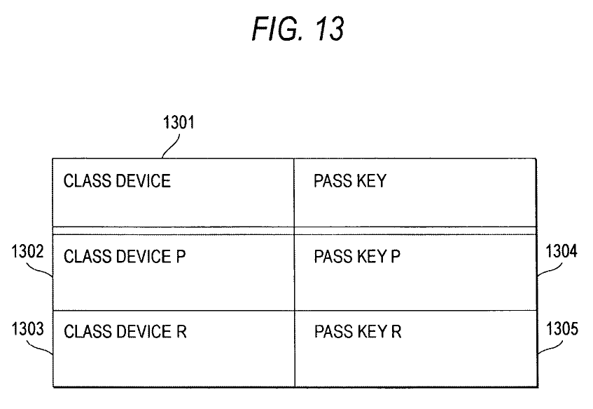

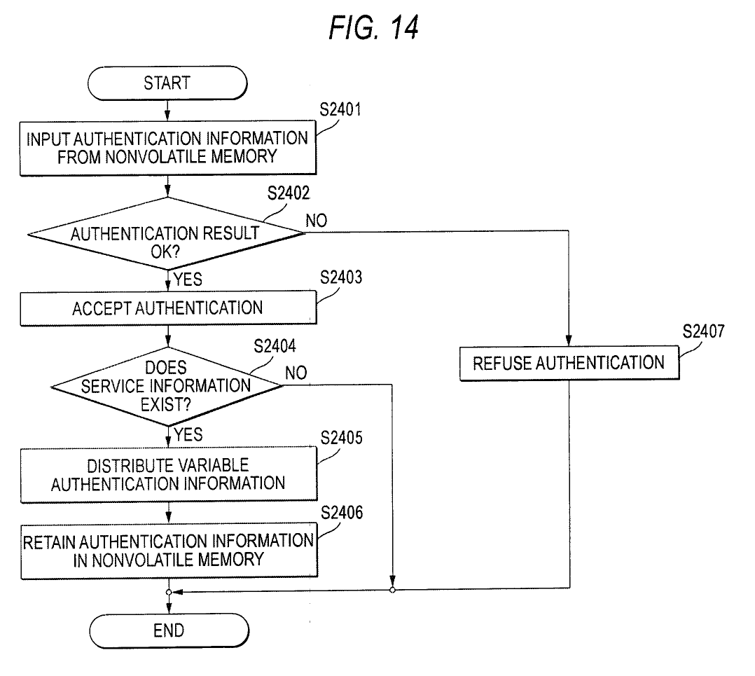

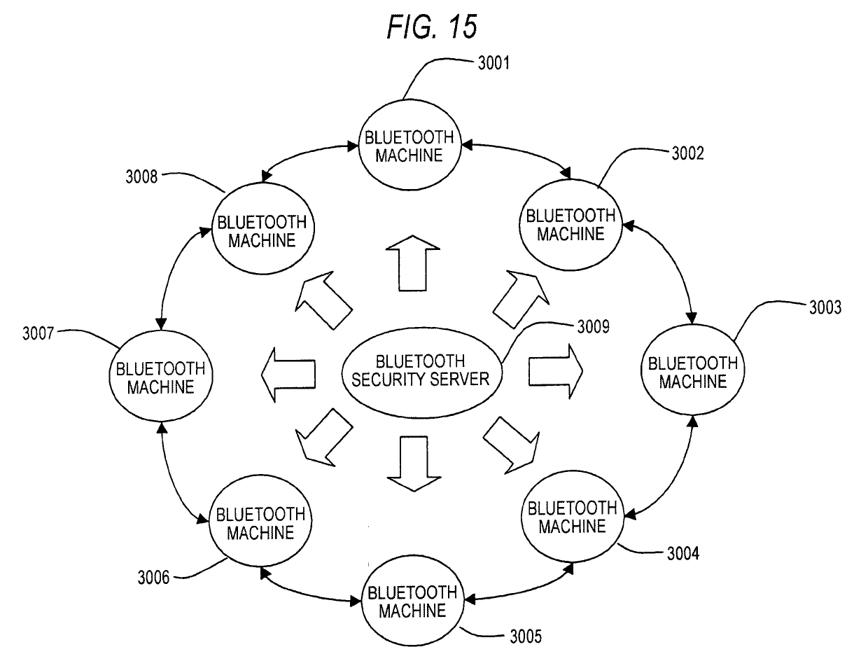

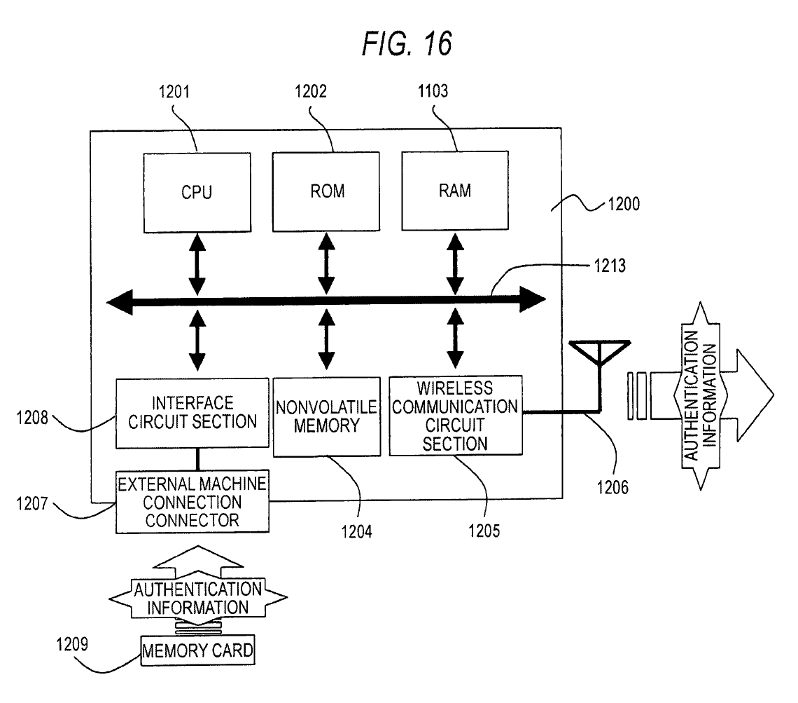

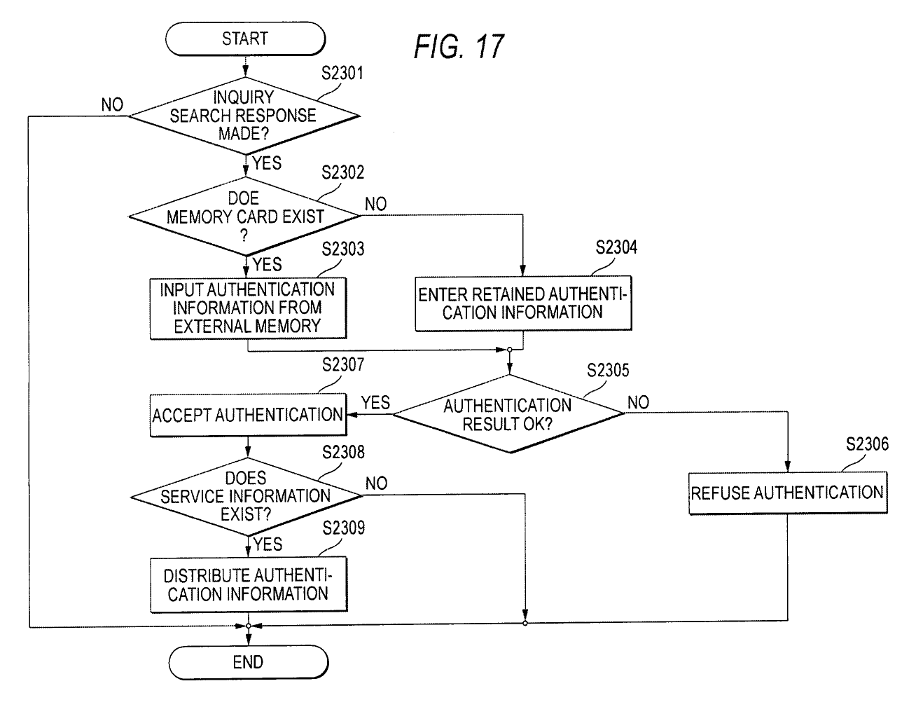

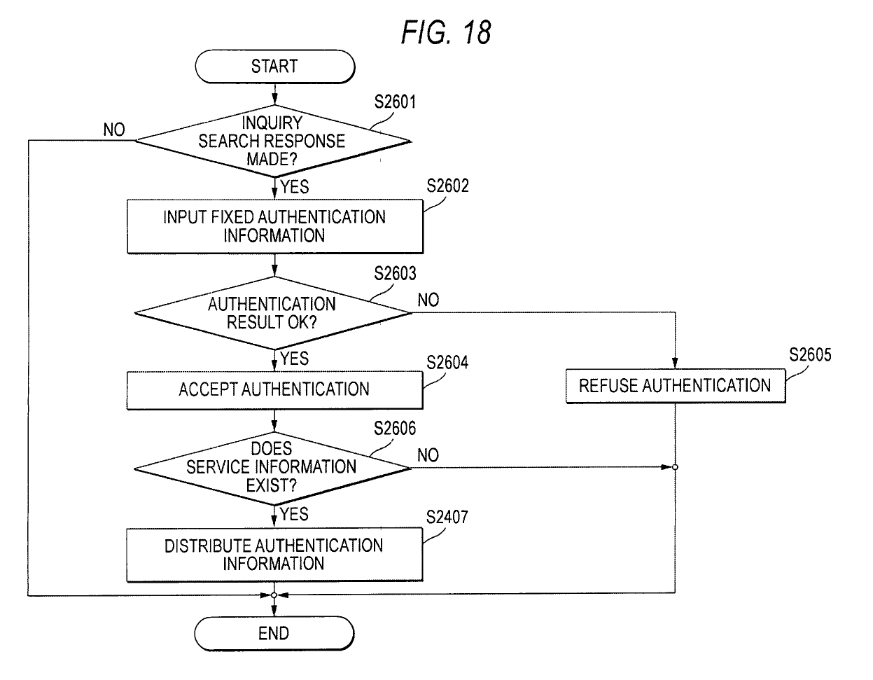

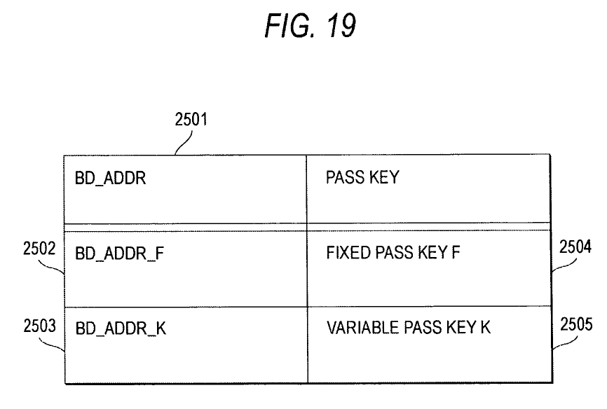

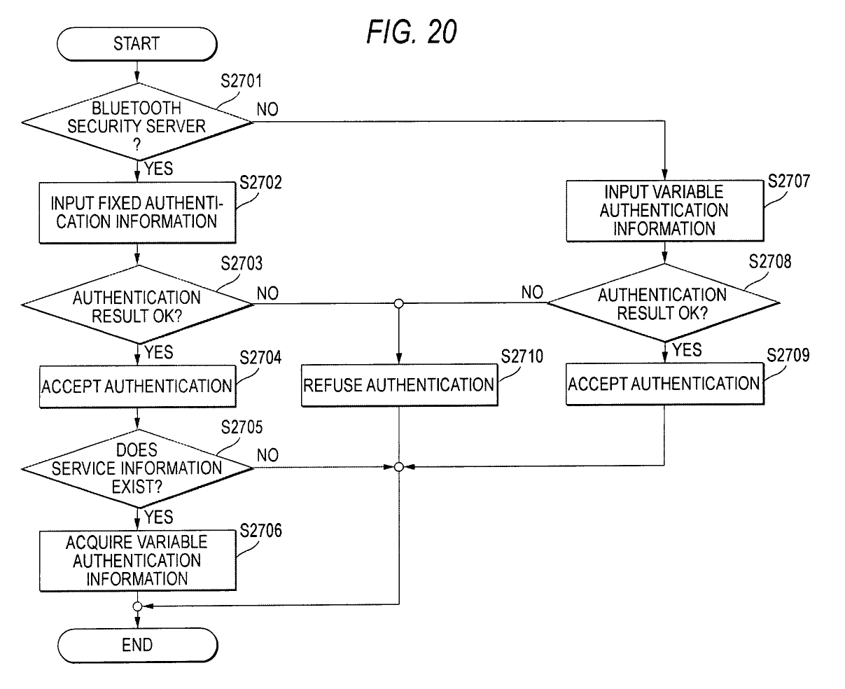

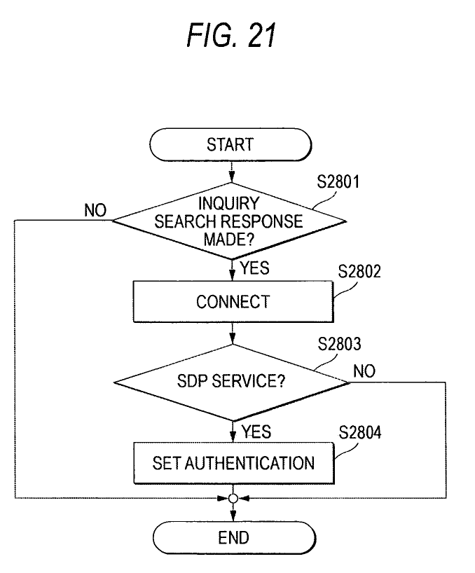

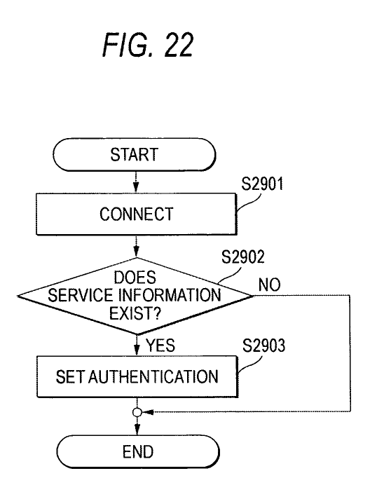

### BRIEF DESCRIPTION OF THE DRAWINGS

[FIG. 1] A block diagram to show the internal configuration of a Bluetooth machine having input means in a related art.

[FIG. 2] A block diagram to show the internal configuration of a Bluetooth machine having no input means in a related art.

[FIG. 3] A drawing to show a list of Bluetooth addresses and pass keys in the related art.

[FIG. 4] A drawing to show a Bluetooth connection authentication sequence in the related art.

[FIG. 5] A flowchart to show a Bluetooth connection authentication flow in the related art.

[FIG. 6] A drawing to show a list of Bluetooth addresses and link keys in the Bluetooth machine in the related art.

[FIG. 7] A drawing to show a Bluetooth connection authentication sequence in the related art.

[FIG. 8] A drawing to show an example of a network mode of Bluetooth machines in the related art.

[FIG. 9] A drawing of the configuration of a Bluetooth machine communication system to describe a first embodiment of the invention.

[FIG. 10] A drawing to show the internal configuration of a Bluetooth security server of the first embodiment.

[FIG. 11] A drawing to show the internal configuration of a Bluetooth machine of the first embodiment.

[FIG. 12] A flowchart to show an authentication information distribution flow of the Bluetooth security server of the first embodiment.

[FIG. 13] A drawing to show an example of a list of class devices and pass keys of the first embodiment.

[FIG. 14] A flowchart to show an authentication information distribution flow of the Bluetooth machine of the first embodiment.

[FIG. 15] A drawing to show an example of a network mode of the Bluetooth machines of the first embodiment.

[FIG. 16] A drawing to show the internal configuration of a Bluetooth security server of a second embodiment of the invention.

[FIG. 17] A flowchart to show an authentication information distribution flow of the Bluetooth security server of the second embodiment.

[FIG. 18] A flowchart to show an authentication information distribution flow of a Bluetooth security server of a third embodiment of the invention.

[FIG. 19] A drawing to show a list of Bluetooth addresses and link keys in a Bluetooth machine of the third embodiment.

[FIG. 20] A flowchart to show an authentication information distribution flow of the Bluetooth machine of the third embodiment.

[FIG. 21] A flowchart to show an authentication setting time operation flow of a Bluetooth security server of the fourth embodiment of the invention.

[FIG. 22] A flowchart to show an authentication setting operation flow of a Bluetooth machine in the fourth embodiment.

[FIG. 23] A drawing to describe the operation of machine authentication in Bluetooth standard.

### DESCRIPTION OF REFERENCE NUMERALS

404 Operation section
405, 604, 1204 Nonvolatile memory
406, 605, 1205 Radio communication circuit section
703 Input authentication information
702a, 702b Authentication information
703 Bluetooth security server
704, 705 Bluetooth machine
1207 External machine connection connector
1208 Interface circuit section
1209 Memory card

### BEST MODE FOR CARRYING OUT THE INVENTION

### First Embodiment

FIG. 9 is a drawing of the configuration of a Bluetooth machine communication system to describe a first embodiment of the invention and shows the concept of Bluetooth authentication information distribution. The communication system shown in the figure is a Bluetooth communication system having an authentication function using authentication information and enabling at least two communication machines to communicate with each other and includes a Bluetooth machine 1 (704), a Bluetooth machine 2 (705), and a security server 703 for wirelessly supplying authentication information to the Bluetooth machine 1 (704) and the Bluetooth machine 2 (705).

The Bluetooth security server 703 is connected as authentication to the Bluetooth machine 1 (704) and the Bluetooth machine 2 (705) and wirelessly distributes authentication information (BD_ADDR and pass key or only pass key of connection communicating party) 702 (702a, 702b). The authentication information 702 is provided for one Bluetooth machine to communicate with another Bluetooth machine and is authentication information used for the Bluetooth machine 703 and the Bluetooth machine 704 to make Bluetooth authentication connection. In the embodiment, the Bluetooth security server 703 is provided independently of the Bluetooth machines, but either Bluetooth machine may be provided with a function of wirelessly supplying authentication information to another Bluetooth machine.

The Bluetooth machine 1 (704) and the Bluetooth machine 2 (705) have each a function of performing authentication with the Bluetooth security server 703 using unique existing authentication information predetermined for each communication machine (first authentication information) and a function of performing authentication between the Bluetooth machines 1 (704) and 2 (705) using authentication information different from the existing authentication information (second authentication information). It is assumed that the predetermined existing authentication information unique for each communication machine (first authentication information) is set in the Bluetooth machine 1 (704) and the Bluetooth machine 2 (705) before authentication information 702a and 702b from the Bluetooth security server 703 are distributed. It is assumed that the Bluetooth security server 703 already knows the existing authentication information of the Bluetooth machine 1 (704) and the Bluetooth machine 2 (705). It is assumed that the existing authentication information is information not leaked to any outsiders. The Bluetooth machine 1 (704) and the Bluetooth machine 2 (705) do not have authentication information input means and the Bluetooth security server 703 has authentication information input means.

The Bluetooth machine 1 (704) and the Bluetooth machine 2 (705) wirelessly acquire authentication information 702 different from the existing authentication information (second authentication information) from the Bluetooth security server 703 and store the authentication information 702 in nonvolatile memory. When the Bluetooth machine 704 and the Bluetooth machine 705 make Bluetooth authentication connection, the authentication information is read from the nonvolatile memory and is used at the authentication processing time.

FIG. 10 is a drawing to show the internal configuration of the Bluetooth security server 703 of the first embodiment. The Bluetooth security server 703 wirelessly supplies authentication information to communication machines and has a CPU 401, ROM 402, RAM 403, an operation section 404, nonvolatile memory 405, a wireless communication circuit section 406, and an antenna 407. The components except the antenna 407 are connected by an internal bus 413 as shown in the figure. The CPU 401 operates in accordance with a program stored in the ROM 402 and controls various types of operation of the Bluetooth security server 703. The ROM 402 is nonvolatile memory previously storing a control procedure, data, etc., of the Bluetooth security server 703. The RAM 403 is used as a work area for conversion work to data transmitted from an external machine, a work area used for computation of the CPU 401, etc., or an area for temporarily storing communication data transmitted and received through the wireless communication circuit section, various settings, etc. The operation section 404 is an input unit from the outside and is made up of buttons, a touch panel, etc. The user of the Bluetooth security server uses the operation section 404 to execute device search, authentication information entry, etc.

The nonvolatile memory 405 is rewritable and stores and retains various settings of the machine, BD_ADDR of the communicating party used for Bluetooth communications, link key information used for communications with the previously connected Bluetooth machine, and the like. The wireless communication circuit section 406 is made up of a high frequency circuit section required for wireless communications, an encoding-decoding circuit section, FIFO memory used at the wireless communication time, nonvolatile memory storing BD_ADDR_D of the machine, pass key D of the machine, and the like, and the antenna 407 is connected to the wireless communication circuit section.

FIG. 11 is a drawing to show the internal configuration of Bluetooth machine 600 of the first embodiment. As shown in the figure, the Bluetooth machine 600 has a CPU 601, ROM 602, RAM 603, nonvolatile memory 604, a wireless communication circuit section 605, and an antenna 606; it is a communication machine for starting communications after authenticating a different communication machine as to whether or not it can communicate with the different communication machine. The components except the antenna 606 are connected by an internal bus 613 as shown in the figure. The CPU 601 operates in accordance with a program stored in the ROM 602 and controls various types of operation of the Bluetooth machine 600. The ROM 602 is nonvolatile memory previously storing a control procedure, data, etc., of the Bluetooth machine 600. The RAM 603 is used as a work area for conversion work to data transmitted from an external machine, a work area used for computation of the CPU 601, etc., or an area for temporarily storing communication data transmitted and received through the wireless communication circuit section 605, various settings, etc. The nonvolatile memory 604 is rewritable and stores and retains various settings of the machine, BD_ADDR of the communicating party used for Bluetooth communications, link key information used for communications with another Bluetooth machine previously connected, and the like. The wireless communication circuit section 605 is made up of a high frequency circuit section required for wireless communications, an encoding-decoding circuit section, FIFO memory used at the wireless communication time, nonvolatile memory storing BD_ADDR_D of the machine, pass key D of the machine, and the like, and the antenna 606 is connected to the wireless communication circuit section. The wireless communication circuit section 605 has a function of extracting and acquiring authentication information from information received at the antenna 606. The antenna 606 and the wireless communication circuit section 605 wirelessly acquire authentication information for communicating with a different communication machine, and the CPU 601 uses the acquired authentication information for authentication.

Next, distribution of the authentication information 702 (second authentication information) shown in FIG. 9 will be discussed in detail based on FIGS. 11, 12, and 13.

FIG. 12 is a flowchart to show an authentication information distribution flow of the Bluetooth security server 703 of the first embodiment. First, the Bluetooth security server 703 uses inquiry search for device search (step S601). The Bluetooth security server 703 checks whether or not BD_ADDR and device class of the responding Bluetooth machine are those of the desired Bluetooth machine 1 (704) or Bluetooth machine 2 (705). If they are those of the Bluetooth machine 1 (704) or the Bluetooth machine 2 (705), the Bluetooth security server 703 goes to step S602; otherwise, the process is terminated. Next, at step S602, when the machine is used first after purchase from the manufacturer, the Bluetooth security server 703 goes to step S603; otherwise, to step S604. At step S603, the Bluetooth security server uses the existing authentication information (first authentication information) retained in the ROM 402 for authentication. Here, it is assumed that the existing authentication information is the setup value unique to the model by the manufacturer at factory shipment and is not leaked to any outsiders. It is assumed that the existing authentication information unique to the model is previously written into the nonvolatile memory 604 of each Bluetooth machine at factory shipment. Then, at the product purchase time, the existing authentication information is changed to information unique to the user with the Bluetooth security server. In this case, it is assumed that the existing authentication information unique to the model at factory shipment is also preset in the Bluetooth security server 703 and the value of the existing authentication information is not displayed for the Bluetooth security server user.

FIG. 13 is a drawing to show an example of a list of class devices and pass keys of the first embodiment. In FIG. 13, the initial connection pass key is set for each device class and the Bluetooth security server 703 uses the pass key at the authentication time. In the Bluetooth machine 1 (704) or the Bluetooth machine 2 (705), similar existing authentication information is set in the nonvolatile memory 604 at factory shipment. At step S604, the user is requested to enter the existing authentication information of the Bluetooth machine 1 (704) or the Bluetooth machine 2 (705) using the operation section 404. If the authentication result is OK at step S605, the process goes to step S607 and authentication is accepted and the process goes to step S608; otherwise, the process goes to step S606 and authentication is refused and the process is terminated.

At step S608, the Bluetooth security server 703 and the Bluetooth machine 1 (704) or the Bluetooth machine 2 (705) exchange service information according to SDP protocol and check mutual functions. If the check result is OK, the process goes to step S609 and the Bluetooth security server distributes authentication information (second authentication information) to the Bluetooth machine 1 (704) or the Bluetooth machine 2 (705). At this time, the Bluetooth security server 703 distributes the authentication information entered by the Bluetooth security server user using the operation unit 404 to the Bluetooth machine 1 (704) or the Bluetooth machine 2 (705). The Bluetooth machine 1 (704) or the Bluetooth machine 2 (705) discards the existing authentication information (first authentication information) set so far and retains the new distributed authentication information (second authentication information). The authentication distribution processing is now complete.

FIG. 14 is a flowchart to show an authentication information distribution flow of Bluetooth machine. The operation of the Bluetooth machine will be discussed by taking the Bluetooth machine 1 (704) as an example. First, from the Bluetooth security server 703, authentication connection is started for the Bluetooth machine 704. At step S2401, the existing authentication information (first authentication information) is acquired from the nonvolatile memory 604 and is used for authentication with the Bluetooth security server 703. If the authentication result is OK at step 2402, the process goes to step S2403 and authentication is accepted and the process goes to step S2404; otherwise, the process goes to step S2407 and authentication is refused and the process is terminated. At step S2404, the Bluetooth security server 703 and the Bluetooth machine 704 exchange service information according to the SDP protocol and check mutual functions. If the check result is OK, the process goes to step S2405 and the Bluetooth security server 703 distributes authentication information (second authentication information) to the Bluetooth machine 704. If the check result is NG, the process is terminated. Next, the process goes to step S2406 and the acquired authentication information is stored in the nonvolatile memory and the process is terminated. The described operation is also performed in the Bluetooth machine 2 (705) in a similar manner.

FIG. 23 is a drawing to describe the operation of machine authentication in the Bluetooth standard and shows authentication processing between the Bluetooth machine 1 (704) and the Bluetooth machine 2 (705). The authentication processing between the Bluetooth machines is similar to that in the related art and therefore will not be discussed again.

In the related art, BD_ADDR and pass key are written into the nonvolatile memory in the Bluetooth machine from an external machine through the external interface of the Bluetooth machine; while, in the first embodiment, BD_ADDR and pass key are written into the nonvolatile memory in the Bluetooth machine through the wireless facility installed in the Bluetooth machine. Here, it is assumed that a USB device connected by a USB cable, etc., a memory card inserted directly into a slot, or the like is used as the external interface and the external machine connected through the external interface. The configuration of the Bluetooth machine of the first embodiment as in FIG. 11 does not require the interface circuit section 108 for external connection or the external connection machine connector 107 as in FIG. 1 and therefore it is made possible to keep down the product cost.

An example of applying the first embodiment to the Bluetooth network mode in the related art shown in FIG. 8 will be discussed as a postscript.

FIG. 15 is a drawing to show an example of the network mode of the Bluetooth machines of the first embodiment. In the figure, it is assumed that the Bluetooth machines are Bluetooth-connected to each other as in FIG. 8. For example, a Bluetooth machine 3001 is Bluetooth-connected to adjacent Bluetooth machines 3002 and 3008. To make the Bluetooth connection, pass key information owned by the Bluetooth machine to be connected to is required as described above. Therefore, in FIG. 15, the Bluetooth machine 3001 needs to acquire the pass key information of the adjacent Bluetooth machines 3001 and 3008. In the embodiment, a Bluetooth security server 3009 wirelessly distributes the authentication information to the Bluetooth machines 3001 to 3008 according to the procedure described above.

Therefore, in the embodiment, even with the network mode shown in FIG. 15 similar to that in the related art, each of the Bluetooth machines 3001 to 3008 need not be provided with the external machine connection connector or the interface circuit. Even the Bluetooth machine having no external interface can be Bluetooth-connected to any other Bluetooth machine, so that the interconnectivity of Bluetooth is also maintained and the Bluetooth machine is an easy-to-use product for the user. The Bluetooth security server 703 is a sole machine, but may be added as an internal function of any one of the Bluetooth machines making up the Bluetooth network.

### Second Embodiment

In the first embodiment, the user of the Bluetooth security server enters authentication information directly. In the first embodiment, there is room for improvement in the case where the authentication information is changed, the case where the authentication information is to be completely concealed from third persons, etc. Then, in a second embodiment, a Bluetooth security server is provided with an external interface and authentication information to be distributed to each Bluetooth machine is input from the external interface.

FIG. 16 is a drawing to show the internal configuration of a Bluetooth security server of the second embodiment of the invention. As shown in the figure, a Bluetooth security server 1209 includes an external machine connection connector 1207 to place a memory card. A memory card 1209 that can be placed in the Bluetooth security server 1200 is placed in a memory card slot of an external machine such as a personal computer, and BD_ADDR and pass key information of Bluetooth machine previously examined are written into a predetermined area of the memory card. To conduct communications, the memory card 1209 is placed in the external machine connection connector 1207. A list of BD_ADDR and pass keys set in the memory card 1209 is similar to the list in the nonvolatile memory 404 contained in the Bluetooth security server 703 previously described in the first embodiment. In the first embodiment, authentication information is entered in the Bluetooth security server 703 using the operation section 404; while, in the second embodiment, authentication information is input using the external interface installed in the Bluetooth security server 1200.

As shown in FIG. 16, the Bluetooth security server 1200 has a CPU 1201, ROM 1202, RAM 1203, nonvolatile memory 1204, a wireless communication circuit section 1205, an antenna 1206, the external machine connection connector 1207, and an interface circuit section 1208, which are connected by an internal bus 1213 as shown in the figure. The CPU 1201 operates in accordance with a program stored in the ROM 1202 and controls various types of operation of the Bluetooth security server 1200. The ROM 1202 is nonvolatile memory previously storing a control procedure, data, etc., of the Bluetooth security server 1200. The RAM 1203 is used as a work area for conversion work to data transmitted from an external machine, a work area used for computation of the CPU 1201, etc., or an area for temporarily storing communication data transmitted and received through the wireless communication circuit section 1205, various settings, etc. The nonvolatile memory 1204 is rewritable and stores and retains various settings of the machine, BD_ADDR of the communicating party used for Bluetooth communications, link key information used for communications with the previously connected Bluetooth machine, and the like. The wireless communication circuit section 1205 is made up of a high frequency circuit section required for wireless communications, an encoding-decoding circuit section, FIFO memory used at the wireless communication time, nonvolatile memory storing BD_ADDR_D of the machine, pass key D of the machine, and the like, and the antenna 1206 is connected to the wireless communication circuit section. The external machine connection connector 1207 is a connector for connecting an external machine and the Bluetooth security server. The interface circuit section 1208 has a function of conducting data communications with an external machine connected through the external machine connection connector 1207. It transmits data to the external machine and receives data from the external machine under the control of the CPU 1201.

FIG. 17 is a flowchart to show an authentication information distribution flow of the Bluetooth security server of the second embodiment and shows the details of distribution of authentication information from the Bluetooth security server 1200 to Bluetooth machines. First, the Bluetooth security server 1200 uses inquiry search for device search (step S2301). The Bluetooth security server 1200 checks whether or not BD_ADDR and device class of the responding Bluetooth machine are those of any desired Bluetooth machine. If they are those of the desired Bluetooth machine, the Bluetooth security server 1200 goes to step S2302; otherwise, the process is terminated.

Next, at step S2302, if a memory card is inserted into the Bluetooth security server, the Bluetooth security server goes to step S2303; otherwise, to step S2304. At step S2303, the Bluetooth security server uses the memory card retaining the existing authentication information of the Bluetooth machine. At step S2304, the Bluetooth security server uses the existing authentication information retained in the nonvolatile memory 1204 for authentication. Here, it is assumed that the existing authentication information retained in the nonvolatile memory 1204 is the setup value unique to the model by the manufacturer at factory shipment and is not leaked to any outsiders. It is assumed that the existing authentication information unique to the model is previously written into the nonvolatile memory of each Bluetooth machine at factory shipment. If the authentication information of the Bluetooth machine at factory shipment is changed, a memory card storing the changed existing authentication information is inserted into the Bluetooth security server and step S2303 is executed. Here, the memory card is distributed from the manufacturer and should be a memory card that cannot be referenced by general users. In the second embodiment, like the first embodiment, at the product purchase time, the authentication information of the Bluetooth machine is changed to information unique to the user with the Bluetooth security server.

If the authentication result is OK at step S2305, the process goes to step S2307 and authentication is accepted and the process goes to step S2308; otherwise, the process goes to step S2306 and authentication is refused and the process is terminated. At step S2308, the Bluetooth security server and the Bluetooth machine exchange service information according to SDP protocol and check mutual functions. If the check result is OK, the process goes to step S2309 and the Bluetooth security server distributes authentication information to the Bluetooth machine. The Bluetooth machine discards the preceding authentication information and retains the new distributed authentication information. The authentication information distribution processing is now complete.

The operation of the Bluetooth machine in the second embodiment is similar to that in the first embodiment and therefore will not be discussed again.

According to the second embodiment, a memory card is placed and the authentication information is input to the Bluetooth security server, so that the authentication information can be input with safety without leaking to the outsiders. If security is ensured between the Bluetooth security server and the memory card 1209 or between the personal computer and the memory card 1209, it is made possible to input the authentication information with more safety.

### Third Embodiment

In the first and second embodiments, the authentication information used between the Bluetooth machines is similar to the authentication information used between the Bluetooth machine and the Bluetooth security server; while, in a third embodiment, variable authentication information is used between Bluetooth machines and fixed authentication information is used between a Bluetooth machine and a Bluetooth security server. The configuration of the third embodiment is similar to that of the first or second embodiment and therefore will not be discussed again in detail.

FIG. 18 is a flowchart to show an authentication information distribution flow of a Bluetooth security server of the third embodiment of the invention and shows a procedure of distributing authentication information of a Bluetooth machine from the Bluetooth security server. First, the Bluetooth security server uses inquiry search for device search (step S2401). The Bluetooth security server checks whether or not BD_ADDR and device class of the responding Bluetooth machine are those of any desired Bluetooth machine. If they are those of the desired Bluetooth machine, the Bluetooth security server goes to step S2402; otherwise, the process is terminated. At step S2602, the Bluetooth security server uses fixed authentication information (first authentication information) with the Bluetooth machine retained in ROM for authentication. Here, it is assumed that the fixed authentication information is the setup value unique to the model by the manufacturer at factory shipment and is not leaked to any outsiders. Fixed pass key is set for each device class as in the first and second embodiments, and the Bluetooth security server uses the pass key at the authentication time. In the Bluetooth machine, similar fixed pass key is set in nonvolatile memory 404 at factory shipment.

FIG. 19 is a drawing to show a list of Bluetooth addresses and link keys in the Bluetooth machine of the third embodiment, and fixed authentication information for connecting at the authentication time with the Bluetooth security server and variable authentication information for connecting the Bluetooth machines is set. If the authentication result is OK at step S2603, authentication is accepted at step S2604 and the process goes to step S2606; otherwise, authentication is refused at step S2605 and the process is terminated. At step S2606, the Bluetooth security server and the Bluetooth machine exchange service information according to the SDP protocol and check mutual functions. If the service information differs, the process is terminated. At step S2607, the Bluetooth security server distributes authentication information (second authentication information) to the Bluetooth machine. At this time, the authentication information distributing method may be either of the methods in the first and second embodiments. The Bluetooth machine discards the preceding variable authentication information and retains the new distributed variable authentication information. The authentication information distribution processing of the Bluetooth security server is now complete.

FIG. 20 is a flowchart to show an authentication information distribution flow of the Bluetooth machine of the third embodiment. First, from the Bluetooth security server, authentication connection is started for the Bluetooth machine. At step S2701, if the connection party is the Bluetooth security server, the process goes to step S2702; otherwise, the process goes to step S2707. At step S2702, authentication information is acquired from nonvolatile memory and is used for authentication with the Bluetooth security server. If the authentication result is OK at step S2703, the process goes to step S2704 and authentication is accepted and the process goes to step S2705; otherwise, the process goes to step S2710 and authentication is refused and the process is terminated.

At step S2705, the Bluetooth security server and the Bluetooth machine exchange service information according to the SDP protocol and check mutual functions. If the check result is OK, the process goes to step S2706 and the Bluetooth security server distributes authentication information to the Bluetooth machine. If the check result is NG, the process is terminated. Next, the process goes to step S2706 and the acquired authentication information is stored in the nonvolatile memory and the process is terminated. If the process goes to step S2707, Bluetooth authentication connection of the Bluetooth machines is applied and thus at the authentication time, variable authentication information is used for authentication at step S2707. If the authentication result is OK, the process goes to step S2709 and the authentication is terminated. If the authentication result is NG, the process goes to step S2710 and the authentication is refused and the process is terminated.

### Fourth Embodiment

The first embodiment is effective only if the existing authentication information (first authentication information) is preset in the Bluetooth machine to which authentication information is to be distributed; while, in a fourth embodiment, a Bluetooth security server can set the presence or absence of authentication in a Bluetooth machine. The machine configuration of the fourth embodiment is similar to that of the first embodiment and therefore will not be discussed again in detail.

FIG. 21 is a flowchart to show an authentication setting time operation flow of a Bluetooth security server of the fourth embodiment of the invention. Here, the case where a Bluetooth machine is set to no authentication and the Bluetooth security server changes the Bluetooth machine to presence of authentication will be discussed. First, the Bluetooth security server uses inquiry search for device search at step S2801. The Bluetooth security server checks whether or not BD_ADDR and device class of the responding Bluetooth machine are those of any desired Bluetooth machine. If they are those of the desired Bluetooth machine, the Bluetooth security server goes to step S2802; otherwise, the process is terminated. Next, at step S2802, the Bluetooth security server connects to the Bluetooth machine with no authentication. At step S2803, the Bluetooth security server and the Bluetooth machine exchange service information according to the SDP protocol and check mutual functions. At step 2804, the Bluetooth security server sets the Bluetooth machine to presence of authentication.

FIG. 22 is a flowchart to show an authentication setting operation flow of a Bluetooth machine in the fourth embodiment. First, at step S2901, the Bluetooth security server attempts to connect to the Bluetooth machine with no authentication. Next, at step S2902, the Bluetooth security server and the Bluetooth machine exchange service information according to the SDP protocol and check mutual functions. At step 2903, the Bluetooth security server sets authentication information in the Bluetooth machine and the Bluetooth machine is set to presence of authentication.

According to the fourth embodiment, it is made possible to wirelessly set the presence or absence of connection authentication of the Bluetooth machine.

In the description of all embodiments, the description about the communication machines compatible with the Bluetooth standard as the communication machines has been given, but the invention is not limited to the description. The invention can be applied to all communication machines in the range without departing from the spirit of the invention that the communication section (Bluetooth security server) wirelessly supplies authentication information to the communication machine (Bluetooth machine).

While the invention has been described in detail with reference to the specific embodiments, it will be obvious to those skilled in the art that various changes and modifications can be made without departing from the spirit and the scope of the invention.

The present application is based on Japanese Patent Application No. (2004-57393) filed on Mar. 2, 2004, which is incorporated herein by reference.

### INDUSTRIAL APPLICABILITY

According to the communication system and the communication method of the invention, the authentication information is wirelessly supplied to the communication machine, whereby the communication machine can acquire the authentication information using the wireless communication function in the related art and need not be provided with new authentication information input means, so that the communication system cost can be reduced, and the invention is useful for a communication system, a communication method, etc., having an authentication function using authentication information and enabling communications to be conducted at least between two communication machines.

1. A communication system having an authentication function using authentication information and enabling communications to be conducted at least between two communication machines, the communication system comprising:
a communication section for wirelessly supplying the authentication information to at least one of the at least two communication machines.

2. The communication system according to claim 1, wherein the communication section is installed in the specific communication machine of the at least two communication machines.

3. The communication system according to claim 2, wherein the communication section installed in the specific communication machine supplies the authentication information to the communication machine other than the specific communication machine, of the at least two communication machines.

4. The communication system according to claim 1, wherein the communication section is installed separately from the at least two communication machines.

5. The communication system according to claim 1, wherein the communication section comprises an external interface and receives the authentication information via the external interface.

6. The communication system according to claim 5, wherein the communication section receives the authentication information retained on a memory card connected to the external interface via the external interface.

7. The communication system according to claim 1, wherein the at least one communication machine comprises:
a function of performing authentication with the communication section using first authentication information uniquely predetermined for each communication machine; and
a function of performing authentication between the at least two communication machines using second authentication information different from the first authentication information.

8. The communication system according to claim 1, wherein the authentication information includes:
fixed authentication information predetermined for each communication machine and used between the communication section and the at least one communication machine; and
variable authentication information generated arbitrarily and used for communications between the at least two communication machines.

9. The communication system according to claim 1, wherein the authentication information is address information or password information of the communicating party.

10. The communication system according to claim 1 the communications between the at least two communication machines or communications between the at least one communication machine and the communication section are wireless communications conforming to Bluetooth standard.

11. A communication method having an authentication function using authentication information and enabling communications to be conducted at least between two communication machines, the communication method comprising:
a supplying step of wirelessly supplying the authentication information to at least one of the at least two communication machines.

12. The communication method according to claim 11, wherein the supplying step is executed between the specific communication machine of the at least two communication machines and the communication machine other than the specific communication machine, of the at least two communication machines.

13. The communication method according to claim 11, wherein the method further comprises a first authentication step of authenticating the at least one communication machine using first authentication information uniquely predetermined for the at least one communication machine, and
wherein, if the at least one communication machine is authenticated in the first authentication step, the authentication information is supplied to the at least one communication machine.

14. The communication method according to claim 13, wherein the method further comprises a second authentication step of authenticating the at least two communication machines using second authentication information different from the first authentication information received by the at least one communication machine.

15. The communication method according to claim 11, wherein the communications between the at least two communication machines or communications with the at least one communication machine are wireless communications conforming to Bluetooth standard.

16. A communication machine having a function of performing authentication as to whether or not mutual communications can be conducted using authentication information and starting communications after the authentication, the communication machine comprising:
means for wirelessly acquiring the authentication information.
